(19) United States
(12) Patent Application Publication
(10) Pub. No.: US 2002/0180575 A1
(43) Pub. Date: Dec. 5, 2002

(54) Inductance component comprising a permanent magnet greater in sectional area than a magnetic path and disposed in a magnetic gap

(75) Inventors: Mizuho Sato, Sendai-shi (JP); Kazuyuki Okita, Sendai-shi (JP); Toru Ito, Miyagi-gun (JP); Gen Daigaku, Sendai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NEC Tokin Corporation, Sendai-shi (JP)

(21) Appl. No.: 10/157,697

(22) Filed: May 29, 2002

(30) Foreign Application Priority Data
May 30, 2001 (JP) 163302/2001

(51) Int. Cl. H01F 21/00

(52) U.S. Cl. 336/110

(57) ABSTRACT

An inductance component includes a magnetic core (11, 12) forming a magnetic circuit having a magnetic gap, an exciting coil (14) wound around the magnetic core, and a permanent magnet (13) disposed in the magnetic gap. The permanent magnet is greater in sectional area than the magnetic core.

### BACKGROUND OF THE INVENTION

This invention relates to an inductance component which is a magnetic device such as a transformer and an inductor and, in particular, to an inductance component comprising a permanent magnet disposed in a magnetic gap formed in a magnetic core.

In order to reduce the size and the weight of an inductance component, it is effective to reduce the volume of a magnetic core comprising a magnetic material. Generally, the magnetic core reduced in size easily reaches magnetic saturation so that a current level handled by a power supply is inevitably decreased. In order to solve the above-mentioned problem, there is known a technique in which the magnetic core is provided with a magnetic gap formed at a part thereof. With this structure, a magnetic resistance of the magnetic core is increased so that the decrease in current level is prevented. In this case, however, the magnetic core is decreased in magnetic inductance.

In order to prevent the decrease in magnetic inductance, proposal is made of a technique related to such a structure that the magnetic core comprises a permanent magnet for generating a magnetic bias. In this technique, a d.c. magnetic bias is given to the magnetic core by the use of the permanent magnet. As a consequence, the number of magnetic lines of flux which can pass through the magnetic gap is increased.

However, the existing inductance component using the permanent magnet is disadvantageous in the following respect. That is, the insertion amount or volume of the permanent magnet disposed in the magnetic gap is determined by a sectional area of a middle leg portion of the magnetic core and the dimension of the magnetic gap. Thus, the magnetic bias given to the magnetic core is inevitably restricted.

### SUMMARY OF THE INVENTION

It is therefore an object of this invention to provide an inductance component capable of increasing the insertion amount of a permanent magnet to thereby obtain an appropriate magnetic biasing effect without varying the dimension of a magnetic gap.

According to this invention, there is provided an inductance component comprising a magnetic core forming a magnetic circuit having a magnetic gap, an exciting coil wound around the magnetic core, and a permanent magnet disposed in the magnetic gap and greater in sectional area than the magnetic core.

### BRIEF DESCRIPTION OF THE DRAWING

FIG. 1 is a perspective view of an inductance component according to a first embodiment of this invention with a part seen through;

FIG. 2 is an exploded perspective view of the inductance component illustrated in FIG. 1;

FIG. 3 is a side sectional view of the inductance component illustrated in FIG. 3;

FIG. 4 is a perspective view of an inductance component as a first comparative example with a part seen through;

FIG. 5 is a graph showing a d.c. superposition inductance characteristic of the inductance component illustrated in FIG. 1 in comparison with those of the first comparative example in FIG. 4 and another example without using a magnetic bias;

FIG. 6 is a perspective view of a modification of the inductance component illustrated in FIG. 1 with a part seen through;

FIG. 7 is a perspective view of an inductance component according to a second embodiment of this invention with a part seen through;

FIG. 8 is a side sectional view of the inductance component illustrated in FIG. 7;

FIG. 9 is a graph showing a d.c superposition inductance characteristic of the inductance component illustrated in FIG. 7 in comparison with those of the first comparative example in FIG. 4 and another example without using a magnetic bias;

FIGS. 10A to 10D are side sectional views showing various modifications of the inductance component illustrated in FIGS. 1 to 3;

FIG. 11 is a perspective view of an inductance component according to a third embodiment of this invention;

FIG. 12 is an exploded perspective view of the inductance component illustrated in FIG. 11;

FIG. 13 is a side sectional view of the inductance component illustrated in FIG. 11;

FIG. 14 is a side sectional view of an inductance component as a second comparative example;

FIG. 15 is a side sectional view of an inductance component as a third comparative example; and

FIG. 16 is a graph showing a d.c. superposition inductance characteristic of the inductance component illustrated in FIG. 11 in comparison with those of the second comparative example in FIG. 14 and the third comparative example in FIG. 15.

### DESCRIPTION OF THE PREFERRED EMBODIMENTS

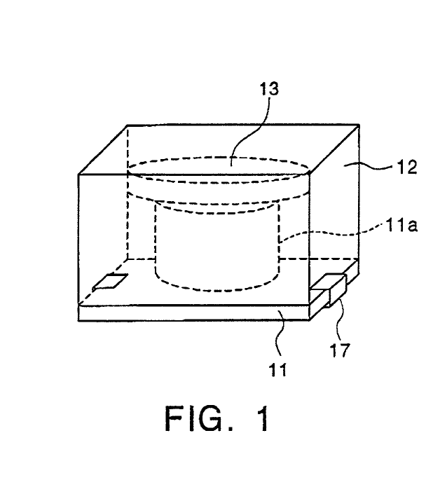

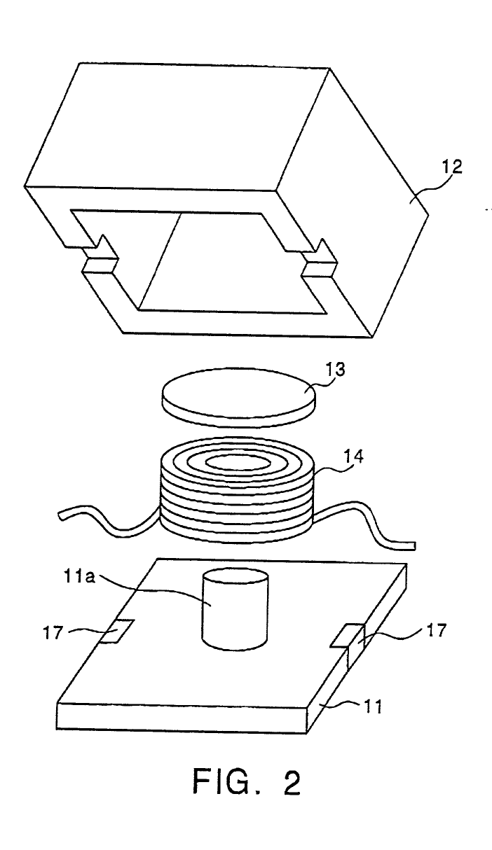

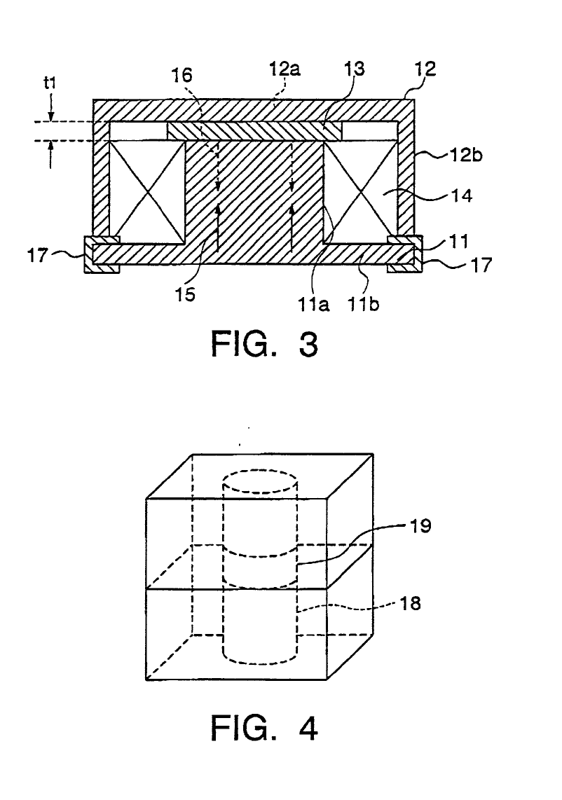

Referring to FIGS. 1 through 3, description will be made of an inductance component according to a first embodiment of this invention

The inductance component illustrated in FIGS. 1 through 3 is adapted to be used as a magnetic device such as a transformer and an inductor. The inductance component comprises a magnetic core composed of first and second core members 11 and 12 faced to each other. The first core member 11 has a cylindrical leg portion 11a at its center. The second core member 12 has a flat or plate-like portion 12a faced to one end of the leg portion 11a through a magnetic gap t1. The first core member 11 further has a flange portion 11b radially outwardly expanding from the other end of the leg portion 11a. The second core member 12 further has a tubular portion 12b extending from an outer peripheral end of the plate-like portion 12a to surround the leg portion 11a and connected to the flange portion 11b.

To the magnetic gap t1 of the magnetic core, a disc-shaped permanent magnet 13 is fitted. Between the leg portion 11a and the tubular portion 12b, an exciting coil 14 is arranged to surround the leg portion 11a. The permanent magnet 13 is arranged so that a magnetic field 16 generated by the permanent magnet 13 is opposite or reverse to a magnetic field 15 generated by the exciting coil 14. Thus, the magnetic field 16 by the permanent magnet 13 and the magnetic field 15 by the exciting coil 14 are opposite to each other. A terminal 17 is attached to an outer peripheral end of the flange portion 11b and connected to the exciting coil 14.

The magnetic core used herein defines a magnetic path having a magnetic path length of 1.75 cm, an effective sectional area of 0.237 cm², and a gap t1 of 230 μm. The exciting coil 14 has 10 turns and a d.c. resistance of 23 m Ω. The permanent magnet 13 has a thickness of 220 μm and a sectional area of 50.3 mm². Thus, the permanent magnet 13 is greater in sectional area than the magnetic path of the magnetic core.

As illustrated in FIG. 4, preparation is made of an inductance component as a first comparative example which comprises a magnetic core having a middle leg portion 18 and a circular permanent magnet 19 having a sectional area of 23.8 mm² substantially similar to that of the middle leg portion 18. In addition, preparation is also made of an inductance component without using a permanent magnet.

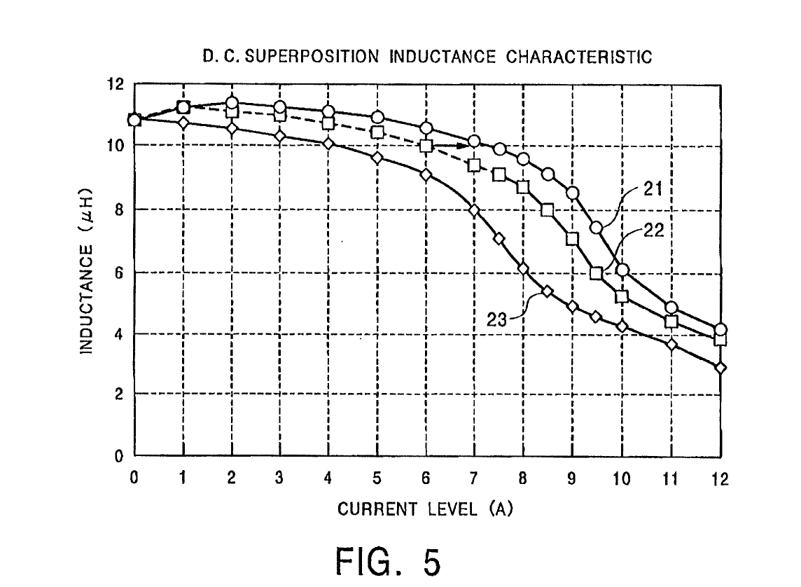

For the inductance component in FIGS. 1 through 3, the inductance component in FIG. 4, and the inductance component without using the magnetic bias, d.c. superposition inductance characteristics are measured. The result is shown in FIG. 5. In FIG. 5, a solid line 21, a broken line 22, and a solid line 23 represent the d.c. superposition inductance characteristics of the inductance component in FIGS. 1 through 3, the inductance component in FIG. 4, and the inductance component without using the magnetic bias, respectively. As is obvious from FIG. 5, the inductance component in FIGS. 1 through 3 is improved in d.c. superposition inductance characteristic by 23% or more as compared with the inductance component in FIG. 4.

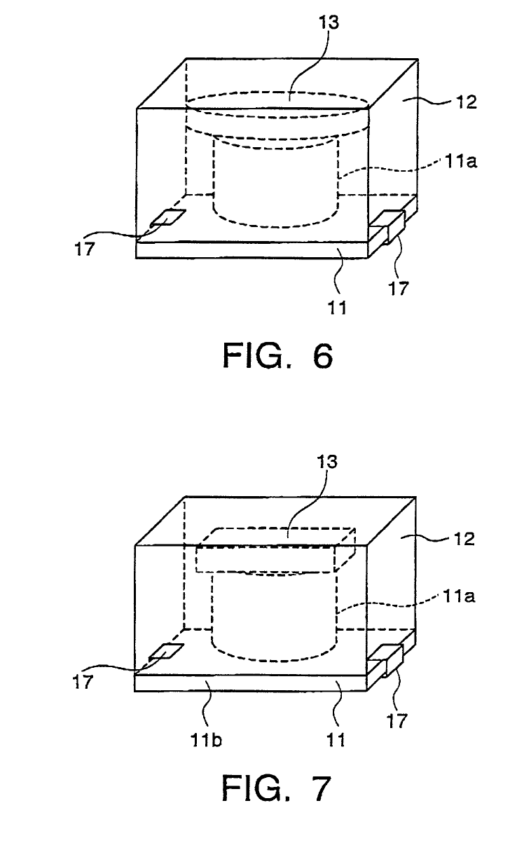

In FIG. 6, a modification of the inductance component in FIG. 1 is shown. As illustrated in the figure, the permanent magnet 13 has a circular section while the middle leg portion 11a of the first core member 11 has a rectangular section.

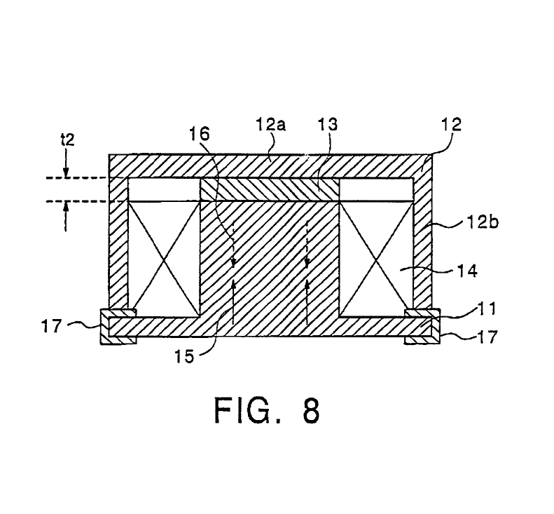

Referring to FIGS. 7 and 8, description will be made of an inductance component according to a second embodiment of this invention. Parts similar in function to those of the inductance component illustrated in FIGS. 1 through 3 are designated by like reference numerals and detailed description thereof will be omitted.

The magnetic core used in this embodiment defines a magnetic path having a magnetic path length of 1.75 cm, an effective sectional area of 0.237 cm², and a gap t2 of 230 m Ω. The exciting coil 14 has 10 turns and a d.c. resistance of 23 m Ω. The leg portion 11a of the first core member 11 has a circular section. The permanent magnet 13 has a thickness of 220 μm and a rectangular shape (square shape) with an area of 30.25 mm².

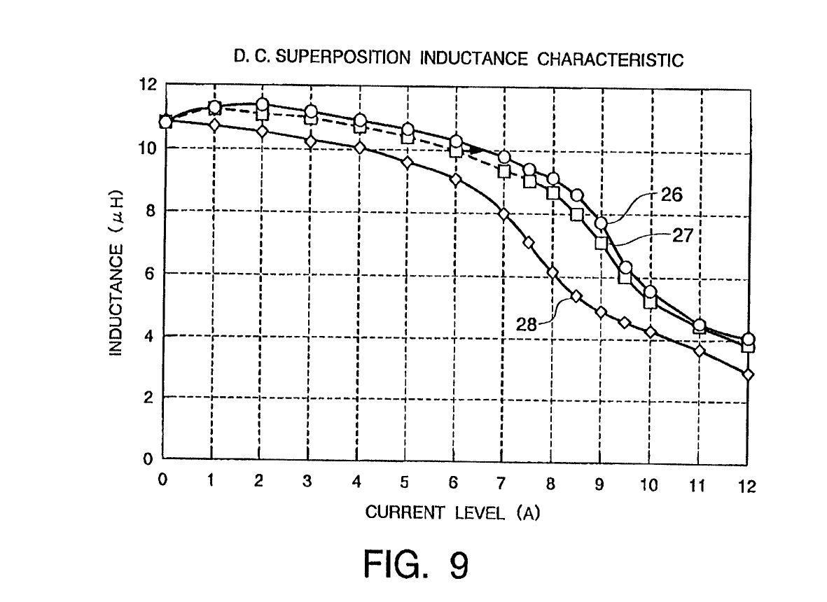

For the inductance component in FIGS. 7 and 8, the inductance component in FIG. 4, and the inductance component without using the magnetic bias, d.c. superposition inductance characteristics are measured. The result is shown in FIG. 9. In FIG. 9, a solid line 26, a broken line 27, and a solid line 28 represent the d.c. superposition inductance characteristics of the inductance component in FIGS. 7 and 8, the inductance component in FIG. 4, and the inductance component without using the magnetic bias, respectively. As is obvious from FIG. 9, the inductance component in FIGS. 7 and 8 is improved in d.c. superposition inductance characteristic by 8% or more as compared with the inductance component in FIG. 4. Furthermore, since the permanent magnet 13 has a rectangular section, it is possible to effectively utilize the material as compared with the circular section.

In each of the foregoing embodiment, the permanent magnet 13 preferably comprises (1) at least one resin selected from polyamide imide resin, polyimide resin, epoxy resin, polyphenylene sulfide resin, silicone resin, polyester resin, aromatic polyamide resin, and liquid crystal polymer and (2) rare earth magnet powder dispersed therein, having an intrinsic coercive force of 10 kOe or more, Tc of 500° C. or more, and an average particle size of 2.5-25 μm, and coated with at least one metal selected from Zn, Al, Bi, Ga, In, Mg, Pb, Sb, and Sn or alloy thereof. Preferably, the resin has a content of 30% or more in volumetric ratio and a specific resistance of 0.1 Ωcm or more.

The rare earth magnet powder preferably has a composition of Sm(Co_{bal.}Fe_{0.15-0.25}Cu_{0.05-0.06}Zr_{0.02-0.03})_{7.0-8.5}.

Preferably, the rare earth magnet powder is coated with an inorganic glass having a softening point between 220° C. and 550° C. Preferably, the metal or the alloy coating the rare earth magnet powder is further coated with a nonmetallic inorganic compound having a melting point not lower than 300° C. The amount of the metal or the alloy, the inorganic glass, or a combination of the metal or the alloy and the nonmetallic inorganic compound preferably falls within a range between 0.1 and 10% in volume.

During production of the permanent magnet, the rare earth metal powder is oriented in a thickness direction in a magnetic field of 25T or more so that the permanent magnet is provided with magnetic anisotropy. The permanent magnet desirably has a center line average roughness of 10 μm or less.

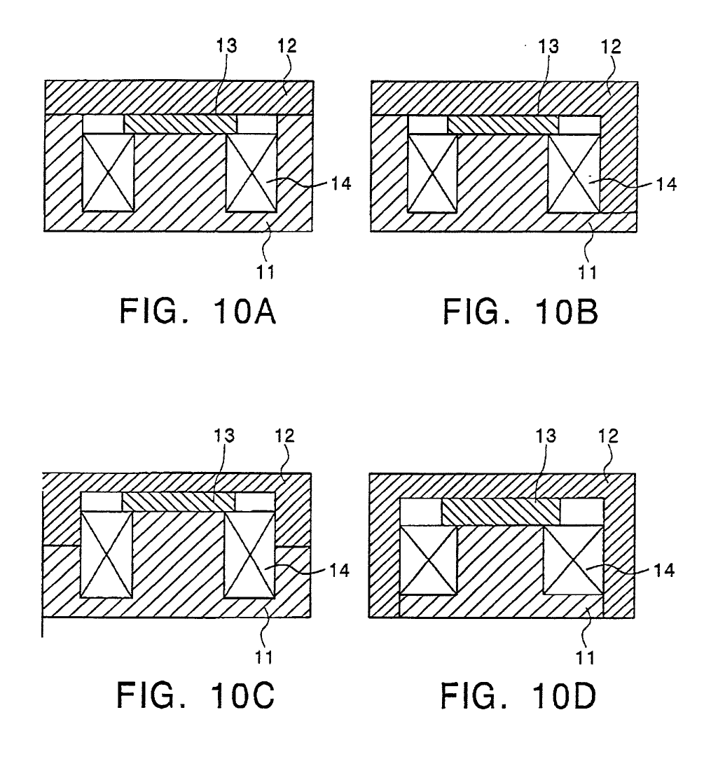

Each of the above-mentioned inductance component can be modified in various manners as illustrated in FIGS. 10A through 10D. Parts having similar functions are designated by like reference numerals. Thus, the shape of the first and the second core members 11 and 12 as well as the shape and the size of the permanent magnet 13 can be modified in various manners.

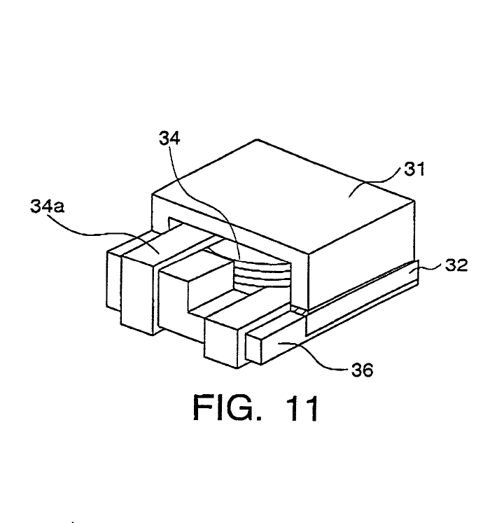

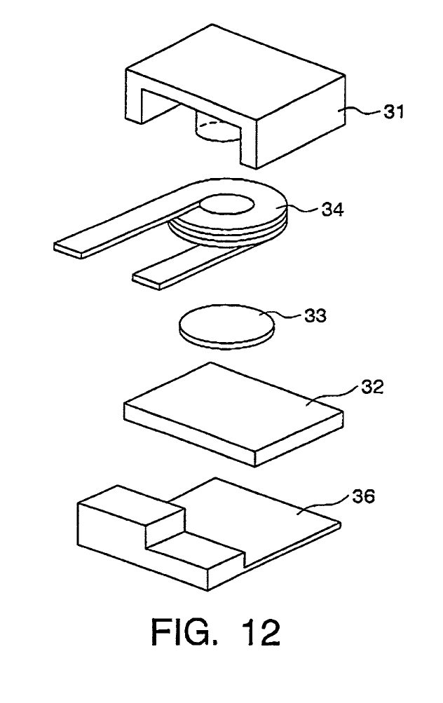

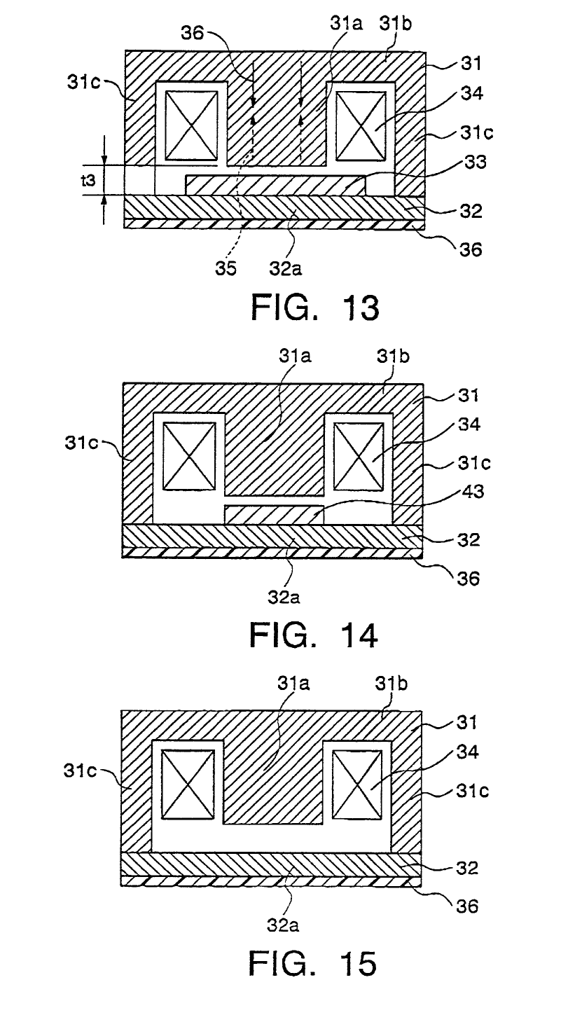

Referring to FIGS. 11 through 13, description will be made of an inductance component according to a third embodiment of this invention.

The inductance component illustrated in FIGS. 11 through 13 is also adapted to be used as a magnetic device such as a transformer and an inductor. The inductance component comprises a magnetic core composed of first and second core members 31 and 32 faced to each other. The first core member 31 comprises an E-shaped magnetic core having a cylindrical leg portion 31a at its center. The second core member 32 comprises an I-shaped magnetic core having a plate-like portion 32a faced to one end of the leg portion 31a through a magnetic gap. The first core member 31 further has a flange portion 31b radially outwardly expanding from the other end of the leg portion 31b and a pair of side plate portions 31c extending from opposite ends of the flange portion 31b in parallel to the leg portion 31a and connected to the plate-like portion 32a.

To the magnetic gap, a permanent magnet 33 is fitted. Between the leg portion 31a and the side plate portions 31c, an exciting coil 34 is arranged to surround the leg portion 31a. The permanent magnet 33 is arranged so that a magnetic field 36 generated by the permanent magnet 33 is opposite or-reverse to a magnetic field 35 generated by the exciting coil 34. Thus, the magnetic field 36 by the permanent magnet 33 and the magnetic field 35 by the exciting coil 34 are opposite to each other.

An insulating base 36 is attached to the plate-like portion 32a. The insulating base 36 is a resin molded product. The exciting coil 34 has a portion 34a extending on or over the insulating base 36 to serve as a terminal known in the art.

The first and the second core members 31 and 32 are made of Mn—Zn ferrite and define a magnetic path having a magnetic path length of 12.3 mm and an effective sectional area, i.e., a sectional area of the leg portion 31a, of 8.0 mm². The magnetic path has a magnetic gap t3 equal to 200 μm. The permanent magnet 33 has a disc shape with a thickness of 150 μm and a diameter of 5 mm. Therefore, the permanent magnet 33 is greater in sectional area than the magnetic path of the magnetic core. The exciting coil 34 has 3 turns.

Comparison will be made between the inductance component in FIGS. 11 to 13 and the inductance component in FIGS. 1 to 3. The leg portion 31a, the flange portion 31b, the side plate portions 31c, the plate-like portion 32a, the permanent magnet 33, and the exciting coil 34 correspond to the leg portion 11a, the flange portion 11b, the tubular portion 12b, the plate-like portion 12a, the permanent magnet 13, and the exciting coil 14, respectively. Therefore, the inductance component in FIGS. 11 to 13 may be modified in the manner similar to those mentioned in conjunction with the first embodiment.

As a second comparative example, an inductance component illustrated in FIG. 14 is prepared. In the inductance component in FIG. 14, the permanent magnet 33 is replaced by a permanent magnet 43 having an area (8.0 mm²) equal to that of the leg portion 31a of the inductance component in FIGS. 11 to 13. The permanent magnet 43 is equal in thickness to the permanent magnet 33.

As a third comparative example, an inductance component illustrated in FIG. 15 is prepared. The inductance component illustrated in FIG. 15 has nothing equivalent or corresponding to the permanent magnet 33 of the inductance component in FIGS. 11 to 13.

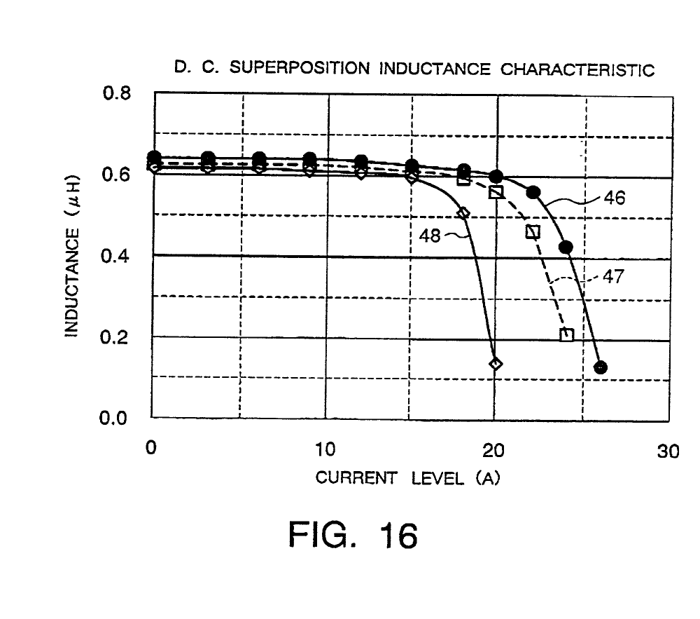

For the inductance components in FIGS. 11 to 13, FIG. 14, and FIG. 15, d.c. superposition inductance characteristics are measured. The result is shown in FIG. 16. In FIG. 16, a solid line 46, a broken line 47, and a solid line 48 represent the d.c. superposition inductance characteristics of the inductance components in FIGS. 11 to 13, FIG. 14, and FIG. 15, respectively. As is obvious from FIG. 16, the inductance component in FIGS. 11 to 13 is improved in d.c. superposition inductance characteristic by 25% or more as compared with the inductance component in FIG. 14.

What is claimed is:

1. An inductance component comprising:
a magnetic core forming a magnetic circuit having a magnetic gap;
an exciting coil wound around said magnetic core; and
a permanent magnet disposed in said magnetic gap and greater in sectional area than said magnetic core.

2. The inductance component according to claim 1, wherein said permanent magnet comprises:
at least one resin selected from polyamide imide resin, polyimide resin, epoxy resin, polyphenylene sulfide resin, silicone resin, polyester resin, aromatic polyamide resin, and liquid crystal polymer; and
rare earth magnet powder dispersed in said at least one resin, having an intrinsic coercive force of 10 kOe or more, Tc of 500° C. or more, and an average particle size of 2.5-25 μm, and coated with at least one metal selected from Zn, Al, Bi, Ga, In, Mg, Pb, Sb, and Sn or alloy thereof, the resin having a content of 30% or more in volumetric ratio and a specific resistance of 0.1 Ωcm or more.

3. The inductance component according to claim 2, wherein said rare earth magnet powder has a composition of Sm(Co_{bal.}Fe_{0.15-0.25}Cu_{0.05-0.06}Zr_{0.02-0.03})_{7.0-8.5}.

4. The inductance component according to claim 2, wherein said rare earth magnet powder is coated with an inorganic glass having a softening point between 220° C. and 550° C.

5. The inductance component according to claim 2, wherein said metal or said alloy coating said rare earth magnet powder is further coated with a nonmetallic inorganic compound having a melting point not lower than 300° C.

6. The inductance component according to claim 2, wherein the amount of said metal or said alloy, said inorganic glass, or a combination of said metal or said alloy and said nonmetallic inorganic compound falls within a range between 0.1 and 10%.

7. The inductance component according to claim 2, wherein said rare earth magnet powder is oriented in a magnetic field applied during production of said permanent magnet so that said permanent magnet is provided with magnetic anisotropy.

8. The inductance component according to claim 2, wherein said permanent magnet is magnetized in a magnetic field of 25T or more.

9. The inductance component according to claim 2, wherein said permanent magnet has a center line average roughness of 10 μm or less.

10. The inductance component according to claim 1, wherein said magnetic core comprises first and second core members faced to each other, said first core member having a leg portion, said second core member having a plate-like portion faced to one end of said leg portion through said magnetic gap.

11. The inductance component according to claim 10, wherein said first core member further has a flange portion radially outwardly expanding from the other end of said leg portion, said second core portion further having a tubular portion extending from an outer peripheral end of said plate-like portion to surround said leg portion and connected to said flange portion.

12. The inductance component according to claim 11, wherein said exciting coil is arranged between said leg portion and said tubular portion to surround said leg portion.

13. The inductance component according to claim 12, further comprising a terminal attached to an outer peripheral end of said flange portion and connected to said exciting coil.

14. The inductance component according to claim 10, wherein said first core member has a flange portion radially outwardly expanding from the other end of said leg portion and a side plate portion extending from an outer peripheral end of said flange portion in parallel to said leg portion and connected to said plate-like portion.

15. The inductance component according to claim 14, wherein said exciting coil is arranged between said leg portion and said side plate portion to surround said leg portion.

16. The inductance component according to claim 15, further comprising an insulating base attached to said plate-like portion, said exciting coil has a portion extending over said insulating base to serve as a terminal.
